(19) United States
(12) Patent Application Publication
(10) Pub. No.: US 2009/0102603 A1
(43) Pub. Date: Apr. 23, 2009

(54) METHOD AND APPARATUS FOR PROVIDING AUTHENTICATION WITH A USER INTERFACE SYSTEM

(76) Inventors: Gene S. Fein, Lenox, MA (US); Edward Merritt, Lenox, MA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/875,641

(22) Filed: Oct. 19, 2007

(51) Int. Cl. G08B 29/00

(52) U.S. Cl. 340/5.81

(57) ABSTRACT

A system, and method for use thereof, for authentication. The system may generate an image in a three dimensional coordinate system, for example a three dimensional lock. A sensing system may sense a user interaction with the image. The user interaction may include a user selecting a sequence, or code, of alphanumeric characters. The sensed user interaction may be correlated with the three dimensional coordinate system. The correlated user interaction may be compared with a predetermined authentication pattern. The predetermined authentication pattern may be a preset alphanumeric sequence indicating an allowed access. The system may also provide a user authentication if a match exists between the correlated user interaction and the predetermined authentication pattern. The system may be used for interconnecting or communicating between two or more components connected to an interconnection medium (e.g., a bus) within a single computer or digital data processing system.

### BACKGROUND OF THE INVENTION

A graphical user interface (GUI) is a type of computer application user interface that allows people to interact with a computer and computer-controlled devices. A GUI typically employs graphical icons, visual indicators or special graphical elements, along with text, labels or text navigation to represent the information and actions available to a user. The actions are usually performed through direct manipulation of the graphical elements.

Holographic images can be created as single or consecutive images using available holographic technology. These technologies include mirrors, lasers, light, and images strategically positioned to cause the proper reflection to yield a holographic image broadcast through an entry point in the laser and mirror positioning system. Black background and rooms with low or no light may enhance the appearance of the holographic image or images, which may also use a holographic plate as a display medium. Holographic systems may be large in size and spread out over a large broadcasting area or may be compact enough to fit in spaces smaller than a desktop. Holographic technology is only limited in size by the size of the component parts. By using holographic technology, images may be displayed multi-dimensionally, rather simply on a planar projection.

Currently, progress has been made in technologies that can enhance the capability and range of holographic media. Specifically, progress has been made in projects that employ multi-million mirror systems and, via companies that have designed specialized high speed and high capacity micro processors for specialized jobs, other than holographic systems. This technology could be applied to holographic technologies to make possible the proper positioning of millions of mirrors at a rate of between 24 to 60 or more frames of video per second, with corresponding synched audio.

Holographic displays generated over the last 20-year period utilize various configurations including lasers with images on glass plates such as an AGFA 8E75HD glass plate or other glass plates as well a laser such as a Spectra Physics 124B HeNe laser, a 35 mW laser diode system utilizing different processing methods such as pyrochrome processing. Split beam techniques can also be used Multi H1 to Multi H2. Such configurations as 8×10, triethanolomine, from Linotronic 300 image setter film are also commonly utilized or a configuration with rear-illuminated for 30×40 cm reflection hologram, where a logo floats 18-inches in front of the plate.

### SUMMARY OF THE INVENTION

Some user interfaces have adopted a multi-dimensional interface approach. For example, the “heliodisplay” of IO2 Technology, LLC of San Francisco, Calif. projects images into a volume of free space, i.e. into an aerosol mixture such as fog or a gas, and may operate as floating touchscreen when connected to a PC by a USB cable. However, with the heliodisplay, the image is displayed into two-dimensional space (i.e. planar). While the Heliodisplay images appear 3 dimensional (“3-D”), the images are planar and have no physical depth reference.

Unfortunately, these existing uses have certain limitations in distribution and deployment. For example. functionally, the heliodisplay is a two dimensional display that projects against a curtain of air, or even glass. While, the heliodisplay may give the appearance of 3-D, the images displayed and the interface are 2-D. As such, the heliodisplay is not a true 3-D holographic display, and thus the interface operates on a two-dimensional plane, not taking advantage of a full three dimensional coordinate system.

Accordingly, there is a need for an integrated User Interface that utilizes true 3-D technology to create a computing and multimedia environment where a user can easily navigate by touch, mouse, voice activation, or pointer system to effectively navigate the interface to raise the level of the user experience to a true 3-D environment, with the goal of attaining elements of the attenuated clarity, realism and benefits of that environment that match our day to day conventional interactions with the 3-D world. With voice activation a user may announce interface positions, or alter a holographic interface, via voice commands.

An embodiment of the present invention relates to the creation of a holographic user interface display system that combines physical media or digitally stored files with a digital holographic player hardware system. The result is the creation of a multimedia holographic user interface and viewing experience, where a variety of graphical schematics enabling cohesive access to information utilizing pyramids, blocks, spheres, cylinders, other graphical representations, existing templates, specific object rendering, free form association, user delegated images and quantum representations of information to form a user interface where the available tools combine over time to match a users evolving data and requests.

Embodiments of the invention provide a holographic user interface which transforms the computing environment to enable a 3-D holographic style user interface and display system. The system utilizes holographic projection technology along with programmed quadrant matrixes sensor field to create multiple methods to select and interact with data and user interface tools and icons presented in a holographic format. The system may be used for interconnecting or communicating between two or more components connected to an interconnection medium (e.g., a bus) within a single computer or digital data processing system.

In an example embodiment of the invention, a system and corresponding method for providing a 3-D user interface involves display images in a 3-D coordinate system. Sensors are configured to sense user interaction within the 3-D coordinate system, so that a processor may receive user interaction information from the sensors. The sensors are able to provide information to the processor that enables the processor to correlate user interaction with images in the 3-D coordinate system.

In another example embodiment of the invention, a system, and corresponding method, for providing an authentication system is presented. The system may comprise at least one projecting unit configured to generate an image in a 3-D coordinate system, at least one sensor configured to sense a user interaction with the image, a correlation unit configured to correlate the user interaction with the 3-D coordinate system, a comparison unit configured to compare the correlated user interaction with a predetermined authentication pattern, and an authenticating unit configured to provide a user authentication if a match exists between the correlated user interaction and the predetermined authentication pattern.

The image may be a holographic image and the predetermined authentication pattern may be a sequence of alphanumeric characters. The correlation unit may be further configured to generate an indication responsive to a correlation of the user interaction with the image in the 3-D coordinate system. The indication may be a displacement of at least a portion of the image in the three dimensional coordinate system.

The at least one sensor in the system may be a laser sensor that may be configured to geometrically identify a position within the three dimensional coordinate system. The at least one sensor may be further configured to triangulate a position within the three dimensional coordinate system. The at least one sensor may also be configured to quadrilate a position within the three dimensional coordinate system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the invention.

FIG. 1 is a block diagram illustrating a holographic user interface according to an example embodiment of the present invention;

FIG. 2 is a flow chart diagram illustrating a method for providing a 3 dimensional (3-D) interface with a system according to an example embodiment of the present invention;

FIG. 3 is a perspective view of sensor field used in connection with an example embodiment of the present invention;

FIGS. 4A and 4B are front views of a holographic user interface device according to an example embodiment of the present invention;

FIG. 5 is a perspective view of a diagram of a holographic user interface according to another example embodiment of the present invention; and

FIG. 6 is an illustrative example in accordance to an example embodiment of the present invention;

FIG. 7 is a schematic of an authentication processor in accordance to an example embodiment of the present invention;

FIG. 8 is a flow chart diagram illustrating operating steps of the methods depicted in FIGS. 6 and 7 in accordance to an example embodiment of the present invention; and

FIGS. 9 and 10 are illustrative examples of a holographic authentication password system in accordance to an example embodiment of the present invention.

### DETAILED DESCRIPTION OF THE INVENTION

A description of example embodiments of the invention follows.

The present invention, in accordance with one embodiment relates to the creation of a holographic user interface which transforms the computing environment to enable a three dimensional (3-D) holographic style user interface and display system. The system utilizes holographic projection technology along with programmed quadrant matrixes sensor field to create multiple methods to select and interact with data and user interface tools and icons presented in a holographic format.

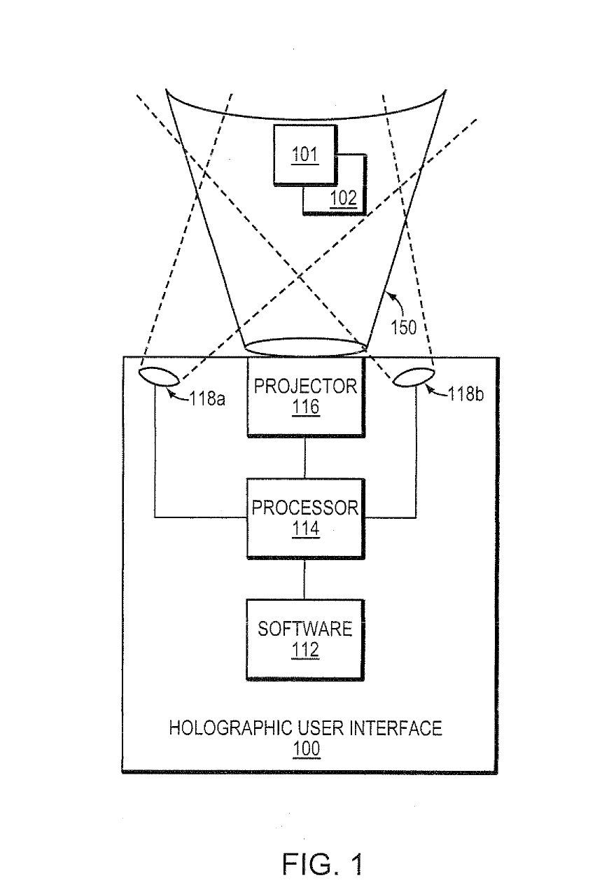

FIG. 1 illustrates a holographic user interface 100 according to one example embodiment of the present invention. The holographic user interface 100 includes a processor 114 that operates software 112, controls a holographic image projector 116, and processes information obtained from sensors 118a, 118b. The projector may generate a 3-D display image 101, 102 within a 3-D coordinate system 150. The sensors 118a and 118b may be directed toward the 3-D coordinate system to sense a user interaction with images within the 3-D coordinate system. If a user were to interact with an image 101 or 102, the sensors 118a and 118b would provide coordinate information that the processor can correlate with the projected images 101 and 102 in the 3-D coordinate system.

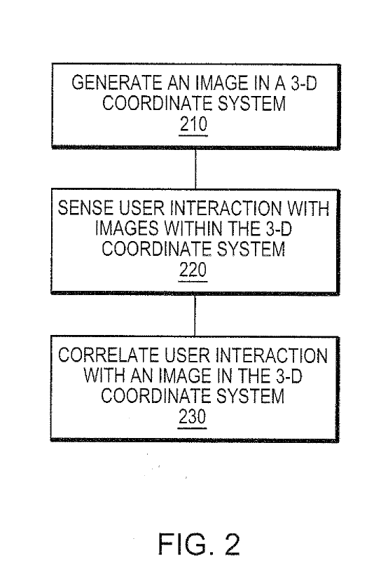

FIG. 2 is a flow chart that illustrates the method for providing a 3 dimensional (3-D) interface with a system. The interface generates (210) an image in a 3-D coordinate system. In operation, an embodiment of the interface deploys holographic information in the form of a user interface template as a default once turned on. Sensors on the interface sense (220) a user's interaction with the 3-D coordinate system. The sensing may occur through the use of matrixes or triangulated data points that correspond to specific functions and data display which the system is capable of displaying. The interface may then correlate (230) the user's interaction with an image in the 3-D coordinate system. By sensing and correlating interaction with the 3-D coordinate system, the interface allows a computer system or display to interact with a user. The holographic data displayed by the system becomes a result of a selection process by the user who triggers data being displayed by key strokes or by the use of a three dimensional interactive interface. Users location commands are read by the system at their exact points and then the system deploys the appropriate response or holographic media based upon the users specific request made via the location of that request.

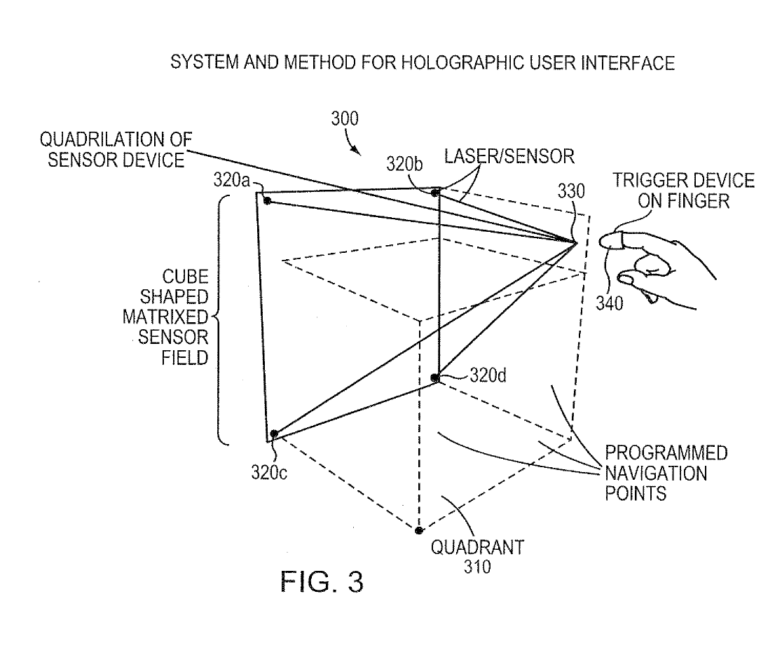

FIG. 3 illustrates a sensor field used in connection with embodiments of the present invention. The embodiment illustrated in FIG. 3 includes four laser sensors 320a-d. The manipulatable interface may be a relatable and interactive holographic media via the use of a sprocketed sensor system which deploys from the display either via a built in or retrofit hardware peripheral that creates a quadrilateral angle navigation system to determine the exact point 330 of a fingertip touch point 340 within a quadrant 310 (also referred to as a “3-D coordinate system”). This touch point, if effectively deployed by the user, is mapped to the image deployed by the holographic hardware and software system, as each image that is displayed in the system is displayed from an exacting point at an exacting place in space that has been preconfigured to match specific points on the quadrilateral sensor system. The points in space attached to programmed images are then matched to touch points made by the user. The touch point may trigger the same functions as a mouse and cursor.

One skilled in the art will recognize that other sensing configurations or devices may be used to sense a location within a 3-D coordinate system. For example, the sensors may be laser sensors configured to provide data to triangulate a point within the 3-D coordinate system, photo voltaic sensors, photo electric light sensors, or image sensors. The sensors may also be motion sensors, which may for example be detected to sense the motion of a user's hand within the 3-D coordinate system. The sensors may be programmed to identify the specific location of the touchpoint 330 that may extend through multiple planar images, to identify a single image located at a 3-D coordinate space.

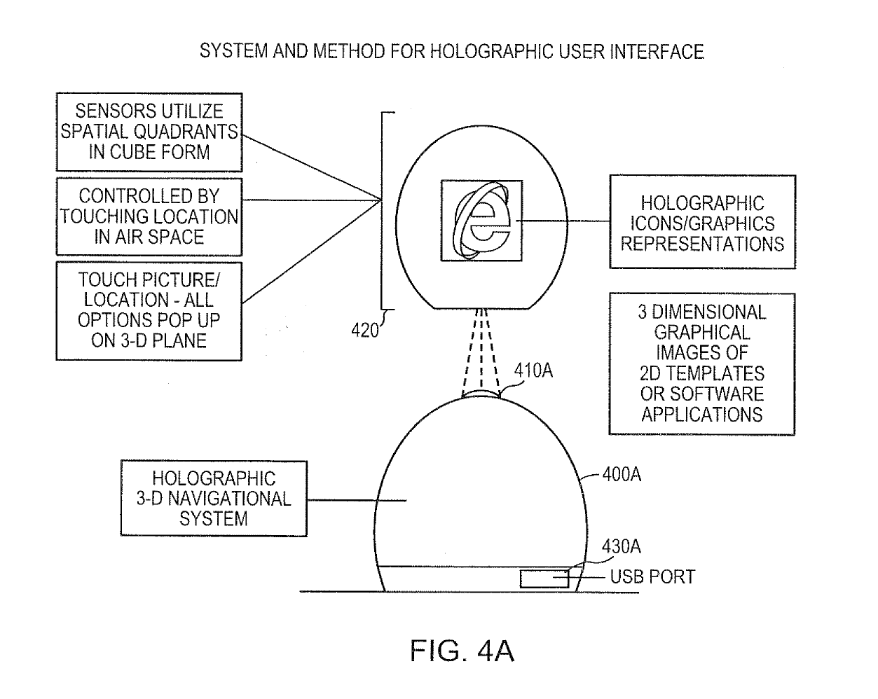

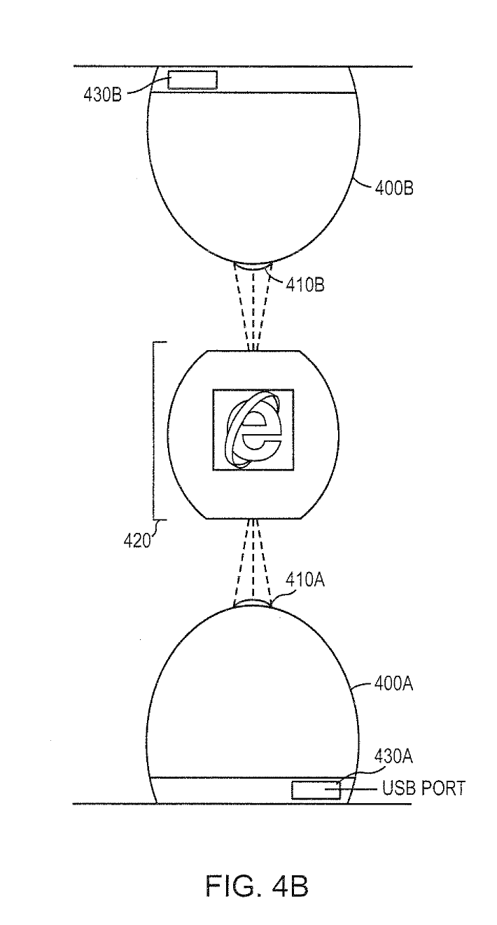

FIG. 4A illustrates a holographic user interface device 400A according to one embodiment of the present invention. The device 400A has a port 410A that may provide the output projector for the multi-dimensional display, and also the sensors for detecting user interaction. The projector and sensors map out a 3-D coordinate system 420 to serve as the holographic user interface. A communications port 430A, such as a universal serial bus (“USB”) port or wireless connection, serves to allow the device 400A to communicate with a computer system. The holographic system may be based upon our prior holographic system technology filing, filed Apr. 5, 2007, U.S. application Ser. No. 11/397,147, which is incorporated herein by reference in its entirety, where the User Interface icons and documents may be saved to a fixed media form and activated by commands sent from the operating system to the device managing the index on the holographic fixed media system and display. Similarly, any system that utilizes holographic displays may also be manipulated and selected using the sensor interface system.

FIG. 4B illustrates holographic user interface devices 400A, as described in relation to FIG. 4A, and 400B. The holographic user interface device 400B may be identical to the holographic user interface device 400A, such that the device 400B may include ports 410B and 430B, and may be configured to provide a holographic image in the 3-D coordinate system 420. Multiple holographic user interface devices may be used to project a holographic image. For example, the user interface device 400A may be configured to project the holographic image from a desk or floor, while the second user interface device 400B may be configured to project the holographic image from a ceiling. If the port 410A of the first user interface device 400A is obstructed by a user or external object, the second interface device 400B may be used to reinforce the obstructed portion of the holographic image. Thus, the full holographic image may be viewed even in the presence of obstructions. It should be appreciated that any number of holographic user interface devices may be employed, and that any number of the user interface devices may be used to sense a user interaction. It should also be appreciated that although the second user interface device 400B has been illustrated in a 180° configuration with respect to the first user interface device 400A, any number of user interface devices may be included and the user interface devices may be offset by any distance or angle.

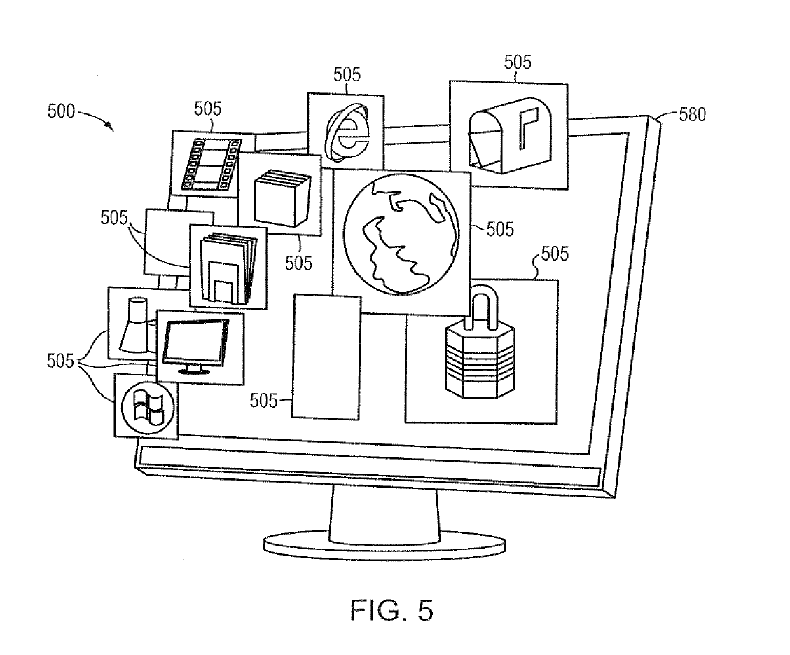

FIG. 5 is a perspective view of a diagram of a holographic user interface 500 according to another embodiment of the present invention. The holographic user interface device may operate with a projection screen 580. Images 505 displayed by the projection screen 580 of the user interface 500 can include, but are not limited to, shapes, graphic images, animation sequences, documents, and audiovisual programs, which may be configured as a logical display featuring icons whose organization on the projection screen 580 may be based upon the users patterns of use with the system. Examples of user patterns with the system may include, but are not limited to, always going online first, always working on a word document second, and always viewing pictures or videos from the users hard drive. These icons could be presented, for example, to the user in an order of priority on the display representing the users evolving use habits based upon history (e.g., distinct changes based upon day, time, and date). These icons, which may include traditional UI operating system icons such as Word document icons and portable document format (“PDF”) icons, may be presented in a holographic format. Documents may be revised and read through in a traditional manner or through a holographic view. Any displayed holographic item may revert back to the flat display monitor, or vice versa, based upon a user command.

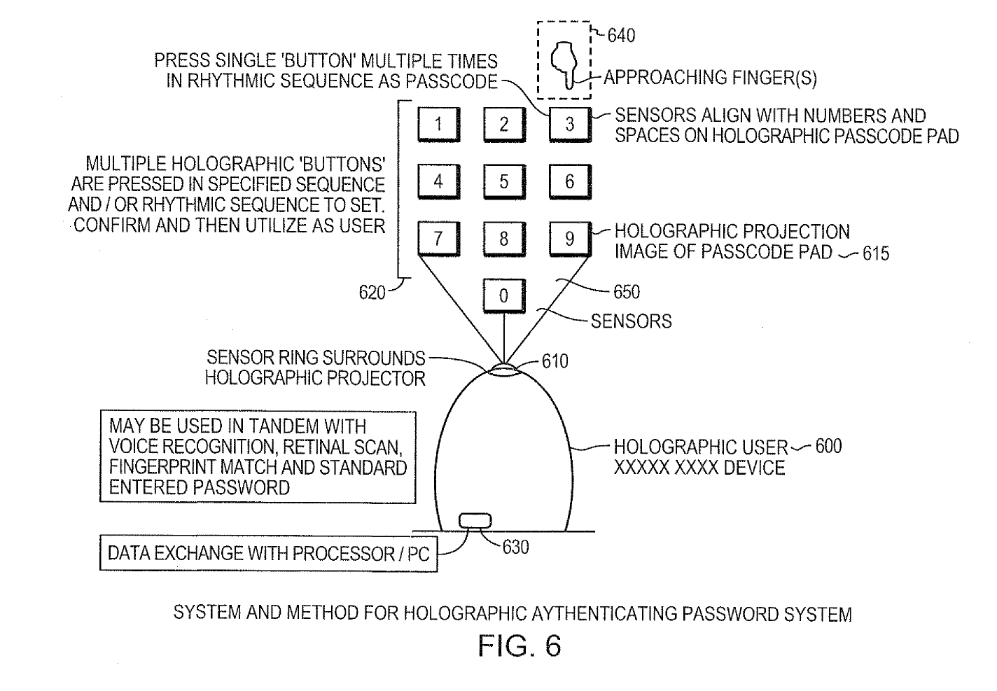

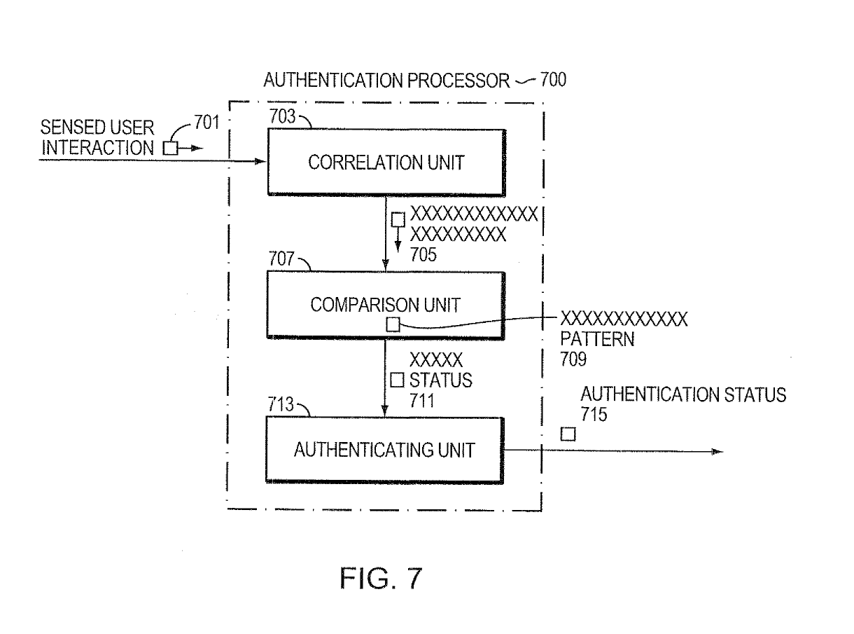

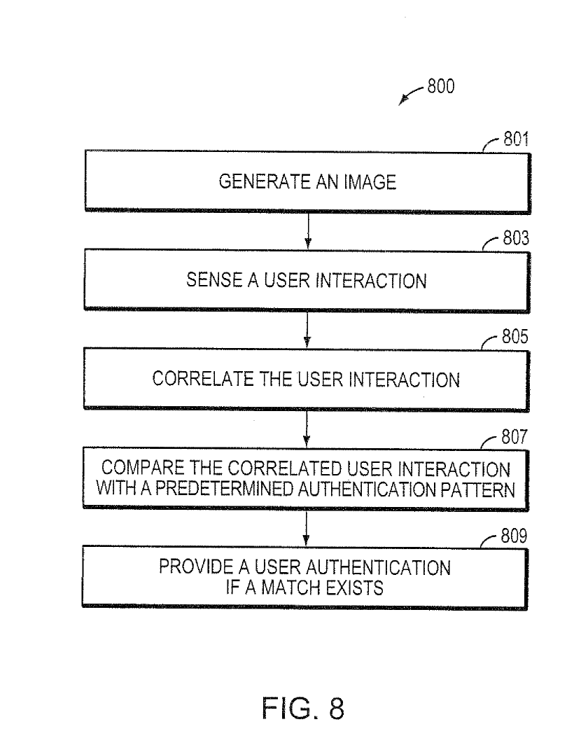

It should be appreciated that the methods involved in providing a 3-D user interface system may be utilized by user and password authentication systems. FIG. 6 illustrates an example of a projection of a holographic image used by an authentication system. FIGS. 7 and 8 illustrate an example of an authentication processor 700 which may be found in a user interface device or host device, and a flow diagram 800 depicting the operative steps of FIG. 6, respectively. The holographic user interface device 600 projects, via a holographic projector 619, a holographic image 615 in a 3-D coordinate system 620 (801).

In the example provided by FIG. 6, the holographic image 615 is a keypad that may be used to key in a numerical code. Sensors within the holographic user interface device 600 may be used to monitor a user interference with the holographic image 615 (803). For example, if a user's hand 640 touches or interferes with the holographic image 615 (e.g., in order to key in the number ‘3’) the sensors may track 650 the image interference.

The user interference 701 detected by the sensors may be sent to an authentication processor 700 in order to correlate the data 701 with the 3-D) coordinate system 620, via a correlation unit 703 (805). This correlated user interaction 705 may be sent to a comparison unit 707 to compare the correlated data 705 with a predetermined authentication pattern 709, for example a pre-set password, in order to determine if a match exists (807). The comparison unit 707 may be configured to send a match status 711 to the authenticating unit 713, in order to report if a match has been found. Using the match status 711 sent by the comparison unit 171, the authenticating unit 713 may send an authentication status 715. If a match does exist between the correlated data 705 and the predetermined authentication pattern 709, a user authentication may be provided (809) allowing a user to, for example, access a password protected computer or files. It should be appreciated that the predetermined authentication pattern may include, but is not limited to, an alphanumeric, color, time, or symbol sequence.

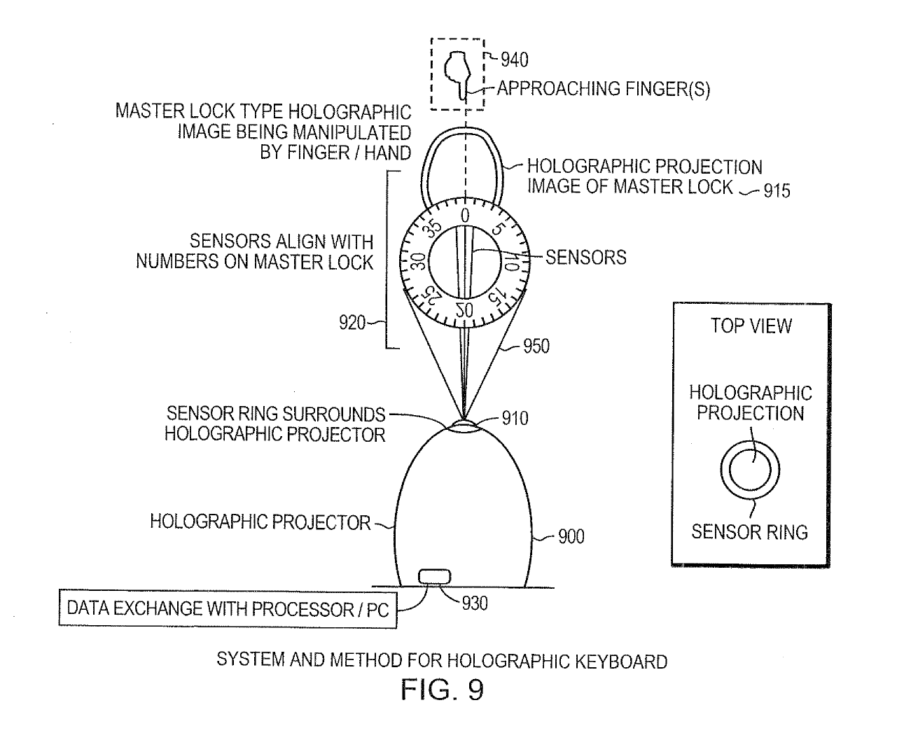

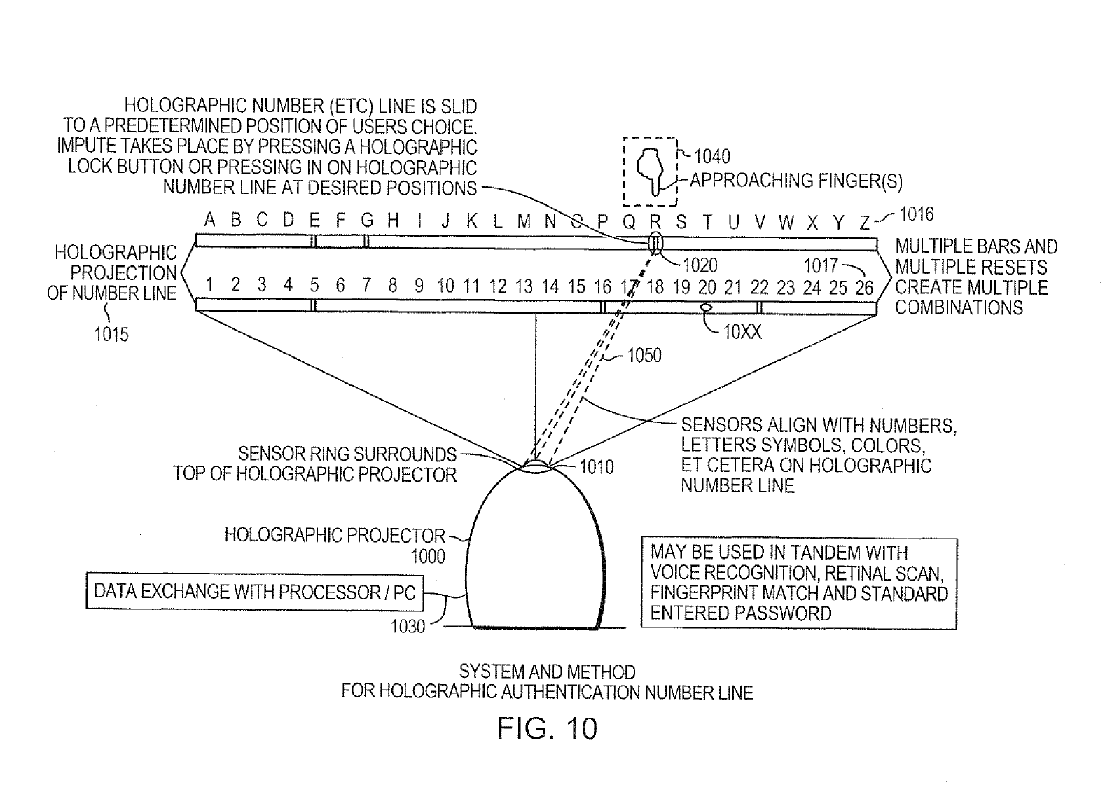

FIGS. 9 and 10 illustrate different examples of holographic images that may be used in the password authentication system. In FIG. 9 the holographic projector 910, of the user interface device 900, projects a holographic image 915 of a combination lock. Typically, a combination lock is a type of lock in which a sequence of numbers, or symbols, is used to open the lock. In the example provided by FIG. 9, the sensors may be configured to detect a user interference, via a user's hand 940. In the example provided by FIG. 9, the user interference may result in a displacement of at least a portion of the holographic image. For example, a user may set the dial of the combination lock image 915 from ‘0’ to ‘5’ which will result in a portion of the holographic image 915 (e.g., the dial) to become displaced or rotated.

The sensors may be configured to detect the movement of the user's hand 940 and correlate that movement with a displacement amount (e.g., the sensors may determine the amount the combination clock will be turned). The possible positions of the combination lock may be stored in a fixed media, as for exampled the fixed media described in U.S. application Ser. No. 11/865,161, where each position may be referenced to an interference pattern. The measured responses from the sensor may be used to determine which interference pattern is to be projected and in what order. Thus, by projecting the interference pattern as dictated by the measured response, the projection of the dial of the combination lock may continuously change positions in accordance with the movement of the user's hand.

The detected user interface data may be correlated to determine which numbers have been set by the user during the user's interference with the holographic image 915. An authentication may be determined as explained in relation to FIGS. 7 and 8.

FIG. 10 provides an example of the holographic projector 1010 projecting a holographic image 1015 of a number line in a sliding rule configuration. A user's hand 1040 may interfere with the holographic image 1015 by sliding any number of bars 1020 on the number line. The sliding bars may be used to select a sequence based on characters 1016, numbers 1017, colors 1018, or any combination thereof. The user's interference may also cause a displacement in at least a portion of the holographic image (e.g., the sliding bars may be displaced). Once a user interaction has been detected by the sensors in the holographic projector 1010, an authentication may be provided as explained in FIGS. 8 and 9.

It should be appreciated that the authentications system may be used in tandem with voice recognition, retinal scan, fingerprint matching, and standard entered password systems. It should also be appreciated that the at least a portion of the holographic image may change positions, or become displaced, as a result of a user input by means of voice recognition, retinal scan, fingerprint matching, or any other known input means. It should also be appreciated that any number of projection systems may be used in the authentication systems. Additionally, the sensors may be located externally from the user interface device.

Those of ordinary skill in the art should recognize that methods involved in providing a 3-D user interface with a system may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer readable medium can also include a communications or transmission medium, such as electromagnetic signals propagating on a computer network, a bus or a communications link, either optical, wired, or wireless, carrying program code segments as digital or analog data signals. The program code enables and supports computer implementation of the operations described in FIGS. 1-10 or any other described embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method of providing authentication through a user interface, the method comprising:
generating an image in a three dimensional coordinate system;
sensing a user interaction with the image;
correlating the user interaction with the three dimensional coordinate system;
comparing the correlated user interaction with a predetermined authentication pattern; and
providing a user authentication if a match exists between the correlated user interaction and the predetermined authentication pattern.

2. The method of claim 1 wherein the image is a holographic image.

3. The method of claim 1 further comprising generating an indication responsive to a correlation of the user interaction with the image in the three dimensional coordinate system.

4. The method of claim 3 wherein the indication is a displacement of at least a portion of the image in the three dimensional coordinate system.

5. The method of claim 1 wherein sensing includes using laser sensors to geometrically identify a position within the three dimensional coordinate system.

6. The method of claim 5 wherein using laser sensors to geometrically identify includes using laser sensors to triangulate and/or quadrilate a position within the three dimensional coordinate system.

7. The method of claim 2 wherein the image is of a lock.

8. The method of claim 1 wherein the predetermined authentication pattern comprises a sequence of alphanumeric characters.

9. A user interface authentication system comprising:
at least one projecting unit configured to generate an image in a three dimensional coordinate system;
at least one sensor configured to sense a user interaction with the image;
a correlation unit configured to correlate the user interaction with the three dimensional coordinate system;
a comparison unit configured to compare the correlated user interaction with a predetermined authentication pattern; and
an authenticating unit configured to provide a user authentication if a match exists between the correlated user interaction and the predetermined authentication pattern.

10. The system of claim 9 wherein the image is a holographic image.

11. The system of claim 9 wherein the correlation unit is further configured to generate an indication responsive to a correlation of the user interaction with the image in the three dimensional coordinate system.

12. The system of claim 11 wherein the indication is a displacement of at least a portion of the image in the three dimensional coordinate system.

13. The system of claim 9 wherein the at least one sensor is a laser sensor configured to geometrically identify a position within the three dimensional coordinate system.

14. The system of claim 13 wherein the at least one sensor is further configured to triangulate and/or quadrilate a position within the three dimensional coordinate system.

15. The system of claim 10 wherein the image is of a lock.

16. The system of claim 9 wherein the predetermined authentication pattern comprises a sequence of alphanumeric characters.

17. A method of providing authentication through a user interface, the method comprising:
correlating a user interaction with a three dimensional coordinate system;
comparing the correlated user interaction with a predetermined authentication pattern; and
providing a user authentication if a match exists between the correlated user interaction and the predetermined authentication pattern.

18. The method of claim 17 wherein the image is a holographic image.

19. The method of claim 17 further comprising generating an indication responsive to a correlation of the user interaction with the image in the three dimensional coordinate system.

20. The method of claim 19 wherein the indication is a displacement of at least a portion of the image in the three dimensional coordinate system.

21. A user interface authentication system comprising:
a correlation unit configured to correlate a user interaction with a image in a three dimensional coordinate system;
a comparison unit configured to compare the correlated user interaction with a predetermined authentication pattern; and
a reporting unit configured to report a user authentication if a match exists between the correlated user interaction and the predetermined authentication pattern.

22. The system of claim 21 wherein the image is a holographic image.

23. The system of claim 21 wherein the correlation unit may be further configured to generate an indication responsive to a correlation of the user interaction with the image in the three dimensional coordinate system.

24. The system of claim 23 wherein the indication is a displacement of at least a portion of the image in the three dimensional coordinate system.

25. The system of claim 21 wherein the predetermined authentication pattern comprises a sequence of alphanumeric characters.
